(19) United States
(12) Patent Application Publication
(10) Pub. No.: US 2016/0251605 A1
(43) Pub. Date: Sep. 1, 2016

(54) METHOD FOR CLARIFYING A FLOWABLE PRODUCT BY WAY OF A CENTRIFUGE

(71) Applicant: GEA MECHANICAL EQUIPMENT GMBH, Oelde (DE)

(72) Inventor: Carsten WAUBKE, Oelde (DE)

(21) Appl. No.: 15/029,729

(22) PCT Filed: Oct. 8, 2014
(86) PCT No.: PCT/EP2014/071578

§ 371 Date: Apr. 15, 2016

(30) Foreign Application Priority Data
Oct. 21, 2013 (DE) 10 2013 111 579.9

(51) Int. Cl. C12C 11/11; B04B 11/04; B04B 1/14

(52) U.S. Cl. CPC C12C 11/11; B04B 1/14; B04B 11/043

(57) ABSTRACT

A method is provided for clarifying a flowable product with a separator that discontinuously automatically empties solid matter and includes a rotary system having a drum that is rotatable by a drive spindle, the drum having an inlet for the product to be clarified and at least one liquid discharge for the continuous discharge of at least one clarified liquid phase and solid-matter discharge openings that are to be opened discontinuously for the discontinuous discharge of the solid phase. The method involves a) determining one or more parameter(s) associated with the vibratory behavior of the rotary system with the aid of at least one vibration sensor and b) initiating a temporally limited solid-matter discharge when or after a limit value for the measured parameter(s) is exceeded.

### BACKGROUND AND SUMMARY OF THE INVENTION

Exemplary embodiment of the invention relate to a method for clarifying a free-flowing product with a separator that discontinuously automatically empties solid matter and has a rotary system with a drum.

German patent document DE 32 28 074 A1 discloses a method that advantageously permits control of a continuously emptying clarifying separator having a drum. A product parameter—here the level of turbidity of a clear phase running out of the drum—is determined and used to monitor the emptying of the solid-matter chamber of the drum. The solid-matter phase is emptied continuously in this case. If the turbidity in the clear phase becomes too high, the clear phase is led back into the drum.

It is also known to use a clarifying separator for the clarification of liquids, in particular beverages, in which the solid matter is discontinuously emptied with the aid of a piston valve for opening and closing discharge openings if the level of turbidity, measured with the photocell, exceeds a certain limiting value.

This method has also proven worthwhile. Nevertheless, there is a need for simple and nevertheless most precise methods for determining a moment that is highly suitable for the emptying of solid matter during the clarification of solid matter from products by using discontinuously automatically emptying separators.

This is particularly true with regard to the processing of pre-clarified beers to which hops have been added for flavoring. The content of hops in the discharge can be determined only with difficulty during a turbidity measurement, since the hops are distributed in the beer in the form of solid particles, but this does not lead to a measurable uniform turbidity.

Exemplary embodiments of the present invention provide a method for clarifying a free-flowing product with a separator that automatically discontinuously empties solid matter and comprises a rotary system having a drum having an inlet for the product to be clarified and at least one liquid discharge for the continuous discharge of at least one clarified liquid phase and solid-matter discharge openings that are to be opened discontinuously for the discontinuous discharge of the solid-matter phase, comprising the following steps: determining one or more parameter(s) associated with the vibration behavior of the rotary system with the aid of a vibration sensor; and initiating a time-limited solid-matter discharge when or after a limiting value for the measured parameter(s) is exceeded. The limiting value can be a direct parameter value or a value associated therewith, for example a derivative.

The direct or indirect determination of a parameter associated with the vibration behavior of the rotary system makes it possible to draw a conclusion about the level of filling of the solid-matter chamber with solid matter that has been separated out of the product and has collected in the solid-matter collecting chamber. In particular, the solid matter must not reach the edge of the disk stack. If, therefore, the parameter determined or the value associated therewith exceeds a predefined limiting value—for example determined during trial operation—or deviates from the latter in a predetermined form, emptying is initiated in order to empty the solid-matter collecting chamber entirely or in any case at least largely of solid matter.

The method according to the invention makes it possible to dispense with a turbidity measurement, so that it is particularly suitable for the clarification of products in which such a measurement does not lead to satisfactory results. The method according to the invention can be used particularly advantageously if, as the starting product, a beer that has been pre-clarified (e.g. with a further separator) is being processed to which there have been added hops, which have to be removed from the beer as the solid matter during the clarification. This is because, in the case of this starting product, the turbidity measurement leads to particularly unsatisfactory results, whereas, shortly before or upon reaching the time that is suitable for emptying the solid matter, the vibrations of the rotary system increase so detectably that the time that is suitable for emptying the solid matter can be determined therefrom.

According to an advantageous variant, the vibration sensor is arranged on or close to a rotating part of the rotary system, in particular on or close to the drive spindle. In this case, it is advantageous if a deflection behavior, in particular the radial deflection of the rotating part, in particular of the drive spindle, and preferably the rotational speed of the rotating part, is measured with the vibration sensor. This method—and in particular the location on the drive spindle—is particularly suitable for an extremely wide range of measurements (e.g. flexure and/or deflection) since the measurements can be carried out simply and particularly precisely here. Alternatively or optionally, the vibration sensor can be arranged on or close to the drum and for the radial deflection behavior of the drum to be determined thereby.

Alternatively, the vibration sensor can be arranged on a non-rotating part, in particular on a frame of the separator. It is then advantageous if an overall vibration—e.g. the sum of the vibrations from 10 Hz to 1000 Hz—is measured with the vibration sensor. It is also possible to carry out an accurate analysis of a wide frequency band over time. This is possible with known vibration measuring systems.

In the event of a sudden rise in the measured values—preferably determined via a determination of a functional derivative—emptying of the solid-matter collecting chamber is suitably initiated, in particular immediately after a rise exceeding a limiting value. The determination of the derivative of the measuring curve makes the determination of the suitable time for emptying particularly simple, since, depending on the product parameters, it is not necessary to determine an absolute measured value at which the emptying is to be initiated.

The method is particularly suitable when the starting product is pre-clarified beer to which hops have been added, which are removed from the beer as solid matter.

The individual method steps do not necessarily have to be carried out in a structural unit of the separator but can also be carried out by external devices (in particular measuring devices, sensors, control unit, individually or in combination of the same and possibly further devices).

The vibration behavior can also be determined using an evaluation of more complex measurements in which, for example, frequency spectra are evaluated, wherein, for example, an observation of a frequency spectrum over time is carried out.

### BRIEF DESCRIPTION OF THE DRAWING FIGURES

The invention will be explained in more detail below by using a preferred exemplary embodiment with reference to the appended drawings, in which:

FIG. 1 illustrates a schematic sectional view of a separator which is operated with the method according to the invention;

FIG. 2 illustrates, in a), a deflection behavior, illustrated in simplified form, of a separator at various frequencies and, in b), the deflection behavior of a drive spindle in relation to drum rotational speed as a function of time until the time at which the solid-matter collecting chamber is emptied is reached.

### DETAILED DESCRIPTION

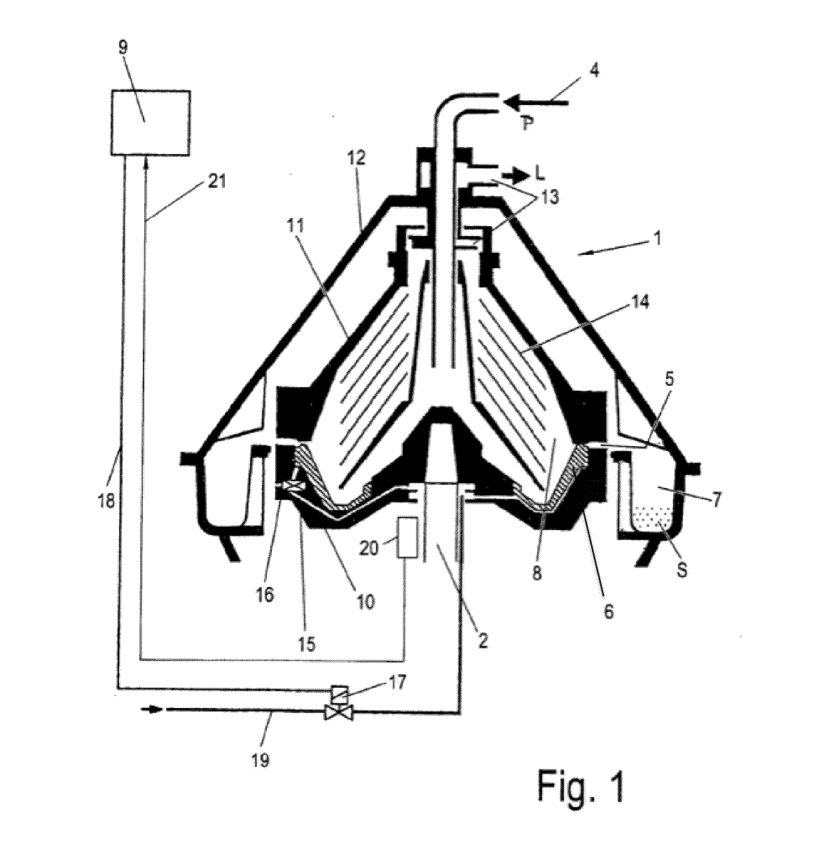

FIG. 1 illustrates a separator 1 for clarifying free-flowing starting products P containing turbid matter, having a drum with a vertical axis of rotation. The processing of the product is carried out in continuous operation. This means that the product is input continuously, as is the discharge of at least one clarified liquid phase, called the clear phase.

The free-flowing starting product P containing turbid matter is preferably a beer, in particular a beer that has already been pre-clarified once and to which hops have been added for flavoring and which have to be removed from the beer again after a certain action time.

The automatically emptying separator has a discontinuous solid-matter discharge for this purpose, wherein the solid matter S—in particular the hops—that has been separated out of a starting product by means of clarification is emptied at intervals by means of opening and re-closing discharge nozzles or discharge openings 5.

The drum has a lower drum part 10 and a drum cover 11. It is also preferably surrounded by a hood 12. The drum is additionally placed on a drive spindle 2, which is rotatably mounted and can be motor-driven.

The drum has a product inlet 4, through which the starting product P to be clarified is led into the drum. It also has at least one outlet 13 with a gripper, which is used to discharge a clear phase L out of the drum. The gripper is a type of centripetal pump. However, the liquid discharge could also be managed with other means. In addition, it would also be conceivable, in addition to the clarification, to perform separation of the product into two liquid phases of different density. A further liquid outlet would be required for this purpose.

The drum preferably has a disk pack 14 made of axially spaced separating disks. Between the outer circumference of the disk pack 14 and the inner circumference of the drum, in the area of the greatest internal diameter of the latter, there is formed a solid-matter collecting chamber 8. Solid matter separated from the clear phase in the area of the disk pack 14 collects in the solid-matter collecting chamber 8, from which the solid matter can be discharged from the drum via the discharge openings 5. The discharge openings 5 can be opened and closed by means of a piston valve 6, which is arranged in the lower drum part 11. When the discharge openings are opened, the solid matter S is thrown out of the drum into a solid-matter collector 7.

To move the piston valve 6, the drum has an actuating mechanism. Here, this comprises at least one feed line 15 for a control fluid such as water and a valve arrangement 16 in the drum and further elements outside the drum. Thus, the input of the control fluid such as water is made possible by a control valve 17 arranged outside the drum, which is arranged in a feed line 19 for the control fluid that is arranged outside the drum, so that, for an emptying action by opening the control valve, the control fluid can be sprayed into the drum or, vice versa, the inflow of control fluid can be interrupted in order to move the piston valve appropriately in order to open the discharge openings. The actuating mechanism—here the control valve 17—is connected via a data line 18 to a control unit 9 for controlling and/or regulating the solid-matter discharge.

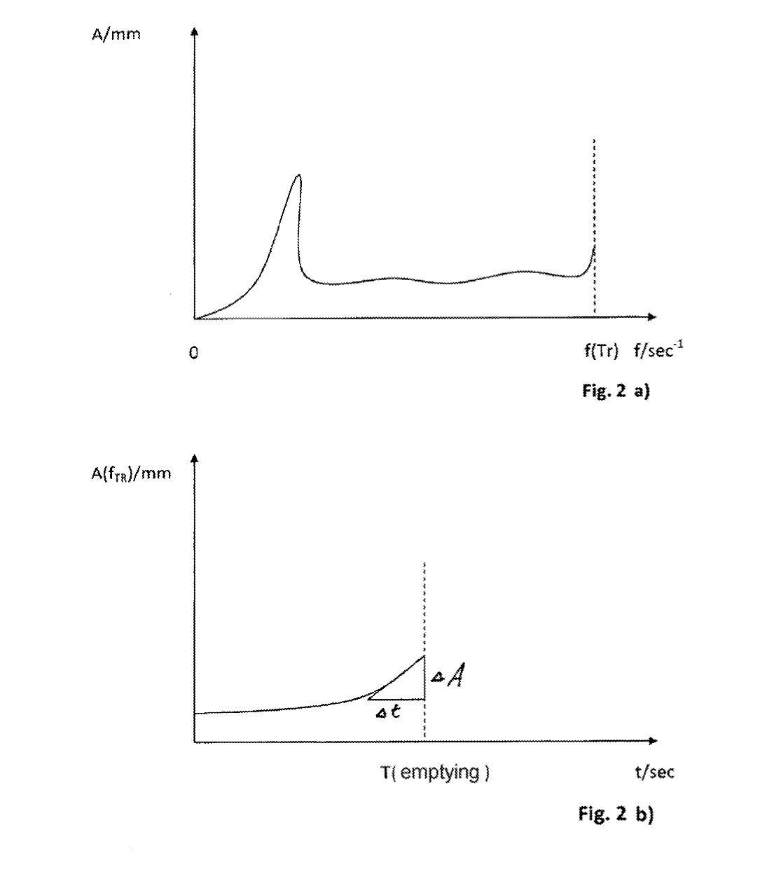

During the clarification of the starting product P, forming the clear phase L, solid matter contained in the starting product—in particular hops during the processing of a pre-clarified beer is collected in the solid-matter collecting chamber 6 of the separator, which is filled. If too much of the solid matter is collected in the collecting chamber 6, the discharge thereof with the clear phase begins (FIG. 2), which should be avoided if possible.

In order to determine the most suitable time to empty solid matter, a vibration sensor 20 is provided. The vibration sensor 20 makes it possible preferably to determine parameters relating to the time-based and location-based deflection behavior of the rotary system.

Preferably, the vibration sensor 20 is arranged on or close to the rotary system for this purpose. In FIG. 1, the vibration sensor 20 is designed and arranged to determine one or more parameters relating to the deflection of the vertically aligned drive spindle 2.

The measurement can be carried out, for example, via one or more inductively acting sensor(s) 20, with which the amplitude of the radial drive spindle is measured as a function of time. Then, using the computer unit 9, an evaluation is carried out. For example, when the radial deflection exceeds a specific pre-stored value, emptying of solid matter is initiated.

This solution is based on the observation that, in a state in which the solid-matter chambers have collected so much solid matter that emptying would intrinsically be necessary, the rotary system tends to more intense vibration, so that the vibration behavior is a good indicator to initiate emptying.

The measuring of the radial deflection of the drive spindle is particularly suitable for this purpose. This is because precise measurements are possible on the drive spindle with simple constructional outlay.

Quite particularly preferably, a neck bearing bridge is used for this arrangement. In addition, not only can the travel be measured but also the acceleration, in order to determine the vibration behavior.

Alternatively, a vibration sensor could also be arranged at another suitable point of the rotary system, for example at a suitable point of the drum.

The vibration sensor is connected via a wired or wire-free data line 21 to the evaluation and control unit 9 (preferably a control computer of the separator), which evaluates the determined measured values and, on the basis of this evaluation, controls the emptying and therefore the opening of the discharge openings 5.

In the following text, an exemplary embodiment of a method according to the invention which is carried out by means of the above-described separator will be explained in more detail.

The starting product P (preferably a beverage, in particular beer, with solid matter) is preferably led continuously into the separator, where said starting product is clarified. A continuous clear phase discharge of the clear phase L is carried out.

Arranged on the drive spindle is the vibration sensor 20, with which, in a first step a), a measurement of the radial deflection of the drive spindle 2 is carried out. Then, in a second step b), the measured value is compared with a predefined and previously stored limiting value. This predefined limiting value can, for example, have been determined previously during measurements in test operation such that it corresponds to a 90% filling of the solid-matter collecting chamber with solid matter.

As long as the limiting value is not reached, the steps a) and b) are run through repeatedly again.

When the limiting value is reached or exceeded, on the other hand, in a third step the solid-matter collecting chamber is emptied by means of an actuation of the piston valve.

In such a way, solid matter can be removed from starting products in which a turbidity measurement does not lead to satisfactory results, in order to determine the time suitable for emptying solid matter. In particular, this is the clarification of the hops from an already pre-clarified beer, to which, following the pre-clarification, hops have been added for flavoring.

FIG. 2a shows, in simplified form, a vibration spectrum of a separator drum up to the drum rotational speed (or f(Tr)). The drum rotational speed is paid particular. Usually, this rotational speed decreases on account of a loss of energy as a result of mass thrown out during emptying actions, and it also changes shortly before emptying actions. In particular, the amplitude of the deflection of the components of the rotating system also clearly changes shortly before the solid-matter collecting chamber is completely filled by solid matter. It is as advantageous to determine the change in the acceleration or the change in the deflection of the drive spindle over time (At/AA; t:=time in sec; A:=amplitude in mm) and thus to determine the derivative of the deflection, e.g. of the drive spindle over time. The measuring interval time and the interval for which the derivative is determined can be, for example, 1 second. If this derivative exceeds a limiting value, at the time T (emptying), such an emptying action is initiated. After that, the amplitude falls again and the measurement of FIG. 2 begins anew. To this extent, FIG. 2b illustrates not only the principle of a particularly advantageous exemplary embodiment of the invention but also illustrates particularly well that the suitable time for an emptying action is advantageously determined via a determination of a derivative of a measured value determination as a function of time.

### LIST OF DESIGNATIONS

1 Separator
2 Drive spindle
3 Sensor
4 Inlet
5 Discharge openings
6 Piston valve
7 Solid-matter collector
8 Solid-matter collecting chamber
9 Evaluation unit
10 Lower drum part
11 Drum cover
12 Hood
13 Outlet
14 Disk pack
15 Line for hydraulic fluid
16 Valve
17 Control valve
18 Data line
19 Hydraulic line
20 Sensor
21 Data line
P Starting product
L Liquid phase/Clear phase
S Solid matter

1-8. (canceled)

9. A method, comprising:
clarifying a free-flowing product with a separator that discontinuously automatically empties solid matter and comprises a rotary system having a drum rotated by a drive spindle, an inlet for the free-flow product, at least one liquid discharge for continuous discharge of at least one clarified liquid phase, and solid-matter discharge openings that are to be opened discontinuously for the discontinuous discharge of the solid-matter phase;
(a) determining, using a vibration sensor, one or more parameter(s) associated with a vibration behavior of the rotary system; and
(b) initiating a time-limited solid-matter discharge when or after a limiting value for the measured parameter(s) is exceeded.

10. The method of claim 9, wherein the vibration sensor is arranged on or close to a rotating part of the rotary system.

11. The method of claim 10, wherein the vibration sensor is arranged on or close to the drive spindle.

12. The method of claim 11, wherein a radial deflection of the drive spindle, over time and a rotational speed of the drive spindle are measured and determined using the vibration sensor.

13. The method of claim 9, wherein the vibration sensor is arranged on a frame of the separator.

14. The method of claim 13, wherein an overall vibration is repeatedly determined using the vibration sensor.

15. The method of claim 9, wherein the determination of whether the limiting value has been exceeded comprises a determination of a derivative of a measured value determination as a function of time.

16. The method of claim 9, wherein the free-flowing product is a pre-clarified beer to which hops have been added and the hops are removed from the beer as the solid phase.
